(19) United States
(12) Patent Application Publication
(10) Pub. No.: US 2022/0333421 A1
(43) Pub. Date: Oct. 20, 2022

(54) Over-Slam Bumper Device for Vehicle

(71) Applicants: Hyundai Motor Company, Seoul (KR); Kia Corporation, Seoul (KR); DMC, INC, Seongnam-si (KR)

(72) Inventors: Sang Moon Kwak, Hwaseong-si (KR); Yunhee Jung, Yongin-si (KR); Youngho Kim, Seoul (KR); Byeong Gu Jang, Yeongcheon-si (KR)

(21) Appl. No.: 17/678,631

(22) Filed: Feb. 23, 2022

(30) Foreign Application Priority Data
Apr. 15, 2021 (KR) 10-2021-0049358

(51) Int. Cl. E05F 5/02; B60J 5/04; B60J 5/10; B62D 25/12

(52) U.S. Cl. CPC E05F 5/022; B60J 5/0468; B60J 5/0456; B60J 5/101; B62D 25/12

(57) ABSTRACT

In an embodiment an over slam bumper device includes a bracket part having one end protruding toward an inside of a tailgate of a vehicle and the other end protruding toward a rear bumper or a vehicle body of the vehicle and fixable to the tailgate and a bumper part inserted into the bracket part and protruding toward the rear bumper or the vehicle body, wherein the bracket part has a hollow shape and includes a first bracket protruding toward the inside of the tailgate and a second bracket protruding toward the outside of the tailgate and having an inner wall on which a screw thread is formed, wherein the bumper part has a hollow shape and includes a coupling portion inserted into the second bracket and having an outer wall on which a screw thread is formed, a deformable portion integrally extending from the coupling portion toward the outside of the tailgate and configured to be compressed and deformed when an external force is applied and a contact portion integrally extending from the deformable portion toward the outside of the tailgate and configured to come into direct contact with the rear bumper or the vehicle body when the tailgate is closed, and wherein the bumper part is inserted into the second bracket.

### CROSS-REFERENCE TO RELATED APPLICATIONS

This application claims the benefit to Korean Patent Application No. 10-2021-0049358 filed in the Korean Intellectual Property Office on Apr. 15, 2021, which application is hereby incorporated herein by reference.

The present invention relates to an over-slam bumper device for a vehicle, and more particularly, to an over-slam bumper device for a vehicle, which includes a bumper part having a hollow shape and a bracket part.

### BACKGROUND

In general, as illustrated in FIG. 1, over-slam bumpers for a vehicle are mounted at two opposite sides (parts ‘A’) of an inner panel of a tailgate 1 and disposed to be directed toward a rear bumper 2 or a vehicle body. The over-slam bumper serves to reduce impact and noise when the tailgate 1 is closed, absorb a level difference, and inhibit vibration of the tailgate 1 while the vehicle travels.

As illustrated in FIG. 2 (2A and 2B), an over-slam bumper in the related art is made of a rubber material and has a simple cylindrical shape. The over-slam bumper includes a bumper part 4, a bracket 5, and a seal 6 and performs an over-slam function for preventing the tailgate 1 from being stabbed when the tailgate 1 is closed. The mounting quality of the vehicle body and the rear bumper needs to be perfect to implement the over-slam function. That is, the tailgate is often difficult to close due to dispersion of assembly operators, vehicle bodies, and assembly quality.

The above information disclosed in this Background section is only for enhancement of understanding of the background of the invention, and therefore it may contain information that does not form the prior art that is already known in this country to a person of ordinary skill in the art.

### SUMMARY

Embodiments provide an over-slam bumper device for a vehicle, which makes it easy to absorb vehicle body dispersion and assembly dispersion and adjust gap/level difference quality.

An exemplary embodiment provides an over-slam bumper device for a vehicle, the over-slam bumper device including: a bracket part having one end protruding toward the inside of a tailgate of a vehicle, and the other end protruding toward a rear bumper or a vehicle body of the vehicle and fixed to the tailgate; and a bumper part inserted into the bracket part and protruding toward the rear bumper or the vehicle body, in which the bracket part has a hollow shape and includes: a first bracket protruding toward the inside of the tailgate; and a second bracket protruding toward the outside of the tailgate and having an inner wall on which a screw thread is formed, in which the bumper part has a hollow shape and includes: a coupling portion inserted into the second bracket and having an outer wall on which a screw thread is formed; a deformable portion integrally extending from the coupling portion toward the outside of the tailgate and configured to be compressed and deformed when an external force is applied; and a contact portion integrally extending from the deformable portion toward the outside of the tailgate and configured to come into direct contact with the rear bumper or the vehicle body when the tailgate is closed, and in which the bumper part is inserted into the second bracket.

The over-slam bumper device for a vehicle according to an embodiment may further include a sealing member interposed between the tailgate and the bracket part and configured to seal the bracket part and the tailgate.

An insertion portion may be further provided in the second bracket and integrally extend from an inner surface of the second bracket.

The bumper part may further include a protruding portion integrally extending from the contact portion and inserted into the insertion portion.

The screw thread formed on the outer wall of the coupling portion may be screw-coupled to the screw thread formed on the inner wall of the second bracket, such that the bumper part is fixed to the bracket part.

The bumper part may be moved relative to the bracket part by being rotated in a state in which the bumper part is screw-coupled to the bracket part.

The deformable portion may be deformed to protrude in a rounded shape toward an outer radius of the bumper part when an external compressive force is applied.

When an external compressive force is maximally applied to the bumper part, a lower surface of the protruding portion may be disposed in the insertion portion and come into contact with an inner surface of the second bracket.

The contact portion may include a plurality of protrusions protruding in a direction perpendicular to a surface of the contact portion.

A first protrusion may be formed on an outer wall of the deformable portion and protrude outward in a direction perpendicular to the outer wall of the deformable portion, a second protrusion may be formed on an outer wall of the second bracket part and protrude in a direction perpendicular to the outer wall of the second bracket part, and the first protrusion and the second protrusion may be disposed such that a relative position between the first protrusion and the second protrusion is changed depending on a relative rotation between the bumper part and the bracket part.

According to the over-slam bumper device for a vehicle according to an embodiment, the equal load is applied by the deformation of the bumper part even though the amount of overlap is changed when the tailgate closed, which makes it possible to absorb vehicle body dispersion and assembly dispersion.

In addition, according to the over-slam bumper device for a vehicle according to an embodiment, the amount of adjustment of the stepped portion may be changed by rotating the bumper part relative to the bracket part.

In addition, according to the over-slam bumper device for a vehicle according to an embodiment, the protrusion is disposed such that the relative position thereof is changed depending on the relative rotation between the bumper part and the bracket part. Therefore, it is possible to check, with the naked eye, the rotation position of the bumper part relative to the bracket part and to adjust the amount of overlap

### BRIEF DESCRIPTION OF THE DRAWINGS

FIG. 1 is a view illustrating a mounting position of an over-slam bumper device in the related art;

FIGS. 2A and 2B are views illustrating a structure of the over-slam bumper device in the related art;

FIG. 3 is a front view illustrating an over-slam bumper device for a vehicle according to an embodiment;

FIGS. 4A and 4B are a front view and a top plan view illustrating a bumper part of the over-slam bumper device for a vehicle according to an embodiment;

FIGS. 5A and 5B are a front view and a top plan view illustrating a bracket part of the over-slam bumper device for a vehicle according to an embodiment;

FIGS. 6A and 6B are a front view and a top plan view illustrating a sealing member of the over-slam bumper device for a vehicle according to an embodiment;

FIGS. 7A and 7B are a front view and a top plan view illustrating cross-sections of the over-slam bumper device for a vehicle according to an embodiment;

FIG. 8 is a view illustrating protrusions provided on the bumper part and the bracket part of the over-slam bumper device for a vehicle according to an embodiment;

FIGS. 9A to 9C are views illustrating states in which a protrusion portion is deformed when an external compressive force is applied to the over-slam bumper device for a vehicle according to an embodiment; and

FIG. 10 is a view illustrating a change in load applied to the protrusion portion as the external compressive force is applied to the over-slam bumper device for a vehicle according to an embodiment.

### DETAILED DESCRIPTION OF ILLUSTRATIVE EMBODIMENTS

Hereinafter, embodiments of the present invention will be described in detail with reference to the accompanying drawings so that those with ordinary skill in the art to which the present invention pertains may easily carry out the embodiments. The present invention may be implemented in various different ways and is not limited to the embodiments described herein.

In addition, the constituent elements having the same configurations in the several embodiments will be assigned with the same reference numerals and described only in the representative embodiment, and only the constituent elements, which are different from the constituent elements according to the representative embodiment, will be described in other embodiments.

It is noted that the drawings are schematic and are not illustrated based on actual scales. Relative dimensions and proportions of parts illustrated in the drawings are exaggerated or reduced in size for the purpose of clarity and convenience in the drawings, and any dimension is just illustrative but not restrictive. The same reference numerals designate the same structures, elements or components illustrated in two or more drawings in order to exhibit similar characteristics. When one component is described as being positioned “above” or “on” another component, one component can be positioned “directly on” another component, and one component can also be positioned on another component with other components interposed therebetween.

The embodiment specifically illustrates an example of the present invention. As a result, various modifications of the drawings are expected. Therefore, the embodiments are not limited to specific forms in regions illustrated in the drawings, and for example, include modifications of forms by the manufacture thereof.

Hereinafter, a structure of an over-slam bumper device for a vehicle according to an embodiment of the present invention will be described in detail with reference to the accompanying drawings.

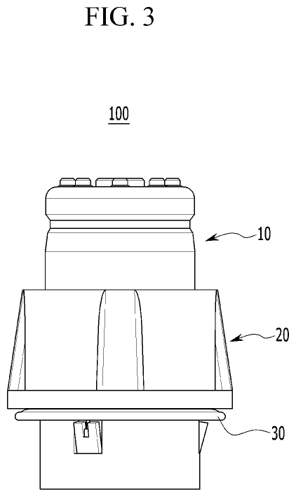

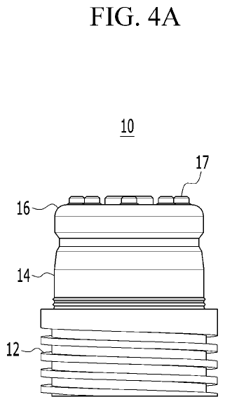

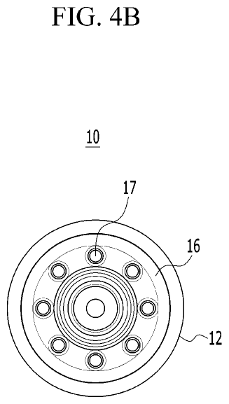

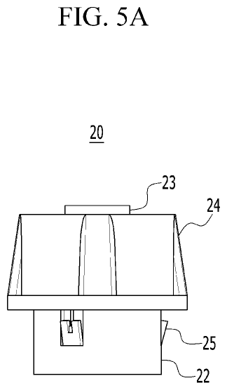

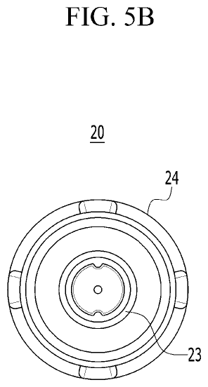

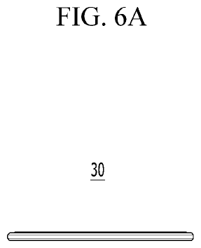

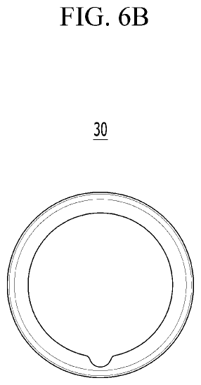

FIG. 3 is a front view illustrating an over-slam bumper device for a vehicle according to an embodiment of the present invention, FIGS. 4A and 4B are a front view and a top plan view illustrating a bumper part of the over-slam bumper device for a vehicle according to an embodiment of the present invention, FIGS. 5A and 5B are a front view and a top plan view illustrating a bracket part of the over-slam bumper device for a vehicle according to an embodiment of the present invention, and FIGS. 6A and 6B are a front view and a top plan view illustrating a sealing member of the over-slam bumper device for a vehicle according to an embodiment of the present invention.

Referring to FIGS. 3 to 6, an over-slam bumper device 100 for a vehicle according to an embodiment of the present invention includes a bracket part 20, a bumper part 10, and a sealing member 30.

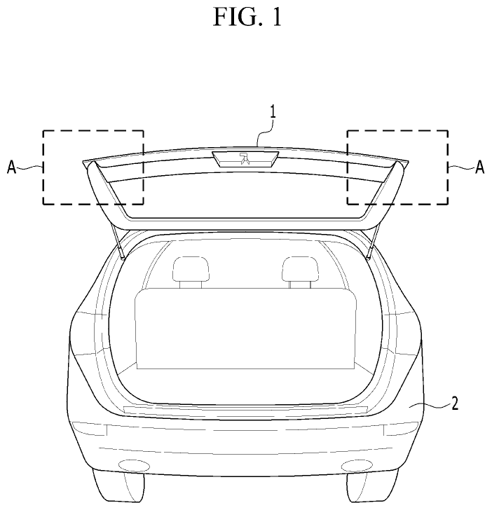

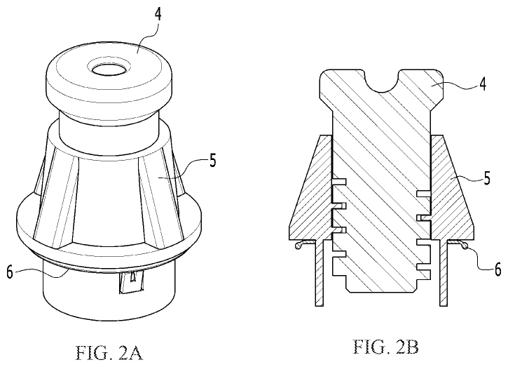

The bracket part 20 is fixed to each of the parts ‘A’ at two opposite sides of the tailgate 1 illustrated in FIG. 1. One end of the bracket part 20 protrudes toward the inside of the tailgate 1, and the other end of the bracket part 20 protrudes toward the rear bumper 2 of the vehicle or the vehicle body. The bracket part 20 has a hollow cylindrical shape and includes a first bracket 22 protruding toward the inside of the tailgate 1 and a second bracket 24 protruding toward the outside of the tailgate 1. A screw thread is formed on an inner wall of the second bracket 24. In addition, an insertion portion 23 may be provided in the second bracket 24 and integrally extend from an inner surface of the second bracket 24.

The first bracket 22 and the second bracket 24 may be integrated and have a stepped portion therebetween. In addition, a radius of the first bracket 22 may be smaller than a radius of the second bracket 24.

The bumper part 10 has a hollow cylindrical shape and is inserted into a hollow portion of the bracket part 20. The bumper part 10 may be inserted into the second bracket 24 of the bracket part 20. A part of the bumper part 10 is inserted into the hollow portion of the bracket part 20, and the remaining part of the bumper part 10 is exposed to the outside of the bracket part 20.

The bumper part 10 may include a coupling portion 12, a deformable portion 14, and a contact portion 16. A screw thread is formed on an outer wall of the coupling portion 12. The screw thread may be screw-coupled to the screw thread formed on the inner wall of the second bracket 24 when the coupling portion 12 is inserted into the second bracket 24. That is, the bumper part 10 may be coupled to the bracket part 20 when the screw threads are screw-coupled to each other by a relative rotation between the bumper part 10 and the bracket part 20. A depth by which the bumper part 10 is inserted into the bracket part 20 may be adjusted depending on the amount of relative rotation between the bumper part 10 and the bracket part 20.

The deformable portion 14 may integrally extend from the coupling portion 12 toward the outside of the tailgate 1 and be compressed and deformed when the external force is applied. The deformable portion 14 may be an elastic member made of a rubber material.

The contact portion 16 comes into direct contact with the rear bumper 2 or the vehicle body when the tailgate 1 is closed. The contact portion 16 integrally extends from the deformable portion 14 toward the outside of the tailgate 1. A plurality of protrusions 17 may be formed on an upper surface of the contact portion 16 and protrude in a direction perpendicular to the upper surface of the contact portion 16. The plurality of protrusions 17 may be arranged in a radial direction. In addition, the plurality of protrusions 17 may each be an elastic member made of a rubber material.

In addition, the bumper part 10 may further include a protruding portion 13 integrally extending from the contact portion 16 and inserted into the insertion portion 23.

The sealing member 30 may have a ring shape and be disposed on the stepped portion between the first bracket 22 and the second bracket 24 of the bracket part 20 and mounted on an outer peripheral surface of the first bracket 22. When the bracket part 20 is fixed to the tailgate 1, the sealing member 30 may be interposed between the tailgate 1 and the bracket part 20 and seal a portion between the bracket part 20 and the tailgate 1. The sealing member 30 may be an elastic member made of a rubber material.

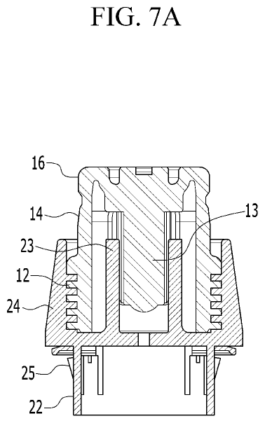

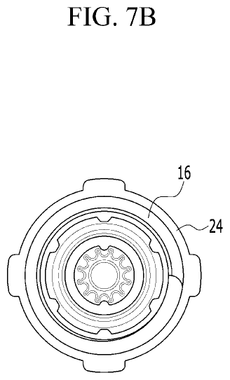

FIGS. 7A and 7B are a front view and a top plan view illustrating cross-sections of the over-slam bumper device for a vehicle according to an embodiment of the present invention.

Referring to FIG. 7 (7A and 7B), the screw thread formed on the inner wall of the second bracket 24 is screw-coupled to the screw thread formed on the outer wall of the coupling portion 12 of the bumper part 10, such that the bumper part 10 may be fixed to the bracket part 20. The bumper part 10 may be moved relative to the bracket part 20 by being rotated in the state in which the bumper part 10 is screw-coupled to the bracket part 20.

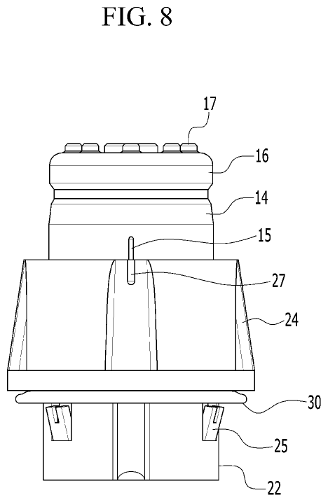

FIG. 8 is a view illustrating protrusions provided on the bumper part and the bracket part of the over-slam bumper device for a vehicle according to an embodiment of the present invention.

As illustrated in FIG. 8, a first protrusion 15 may be formed on an outer wall of the deformable portion 14 and protrude outward in a direction perpendicular to the outer wall of the deformable portion 14, and a second protrusion 27 may be formed on an outer wall of the second bracket part 24 and protrude in a direction perpendicular to the outer wall of the second bracket part 24. The first protrusion 15 and the second protrusion 27 may be disposed such that a relative position between the first protrusion 15 and the second protrusion 27 is changed depending on the relative rotation between the bumper part 10 and the bracket part 20. The first protrusion 15 and the second protrusion 27 may be visually recognized. A degree of the relative rotation between the bumper part 10 and the bracket part 20 may be recognized based on the relative position between the first protrusion 15 and the second protrusion 27. A height by which the bumper part 10 protrudes from the bracket part 20 may be adjusted by adjusting the degree of the relative rotation, thereby adjusting the overlap amount and closing strength of the tailgate 1.

Meanwhile, a plurality of hooks 25 may be formed on the outer wall of the first bracket 22 and allow the first bracket 22 and the tailgate 1 to hook-engage with each other to prevent the bracket part 20 from separating from the tailgate 1 when the bracket part 20 is fixed to the tailgate 1.

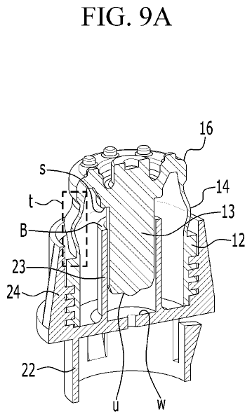

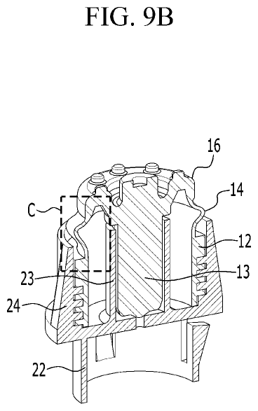

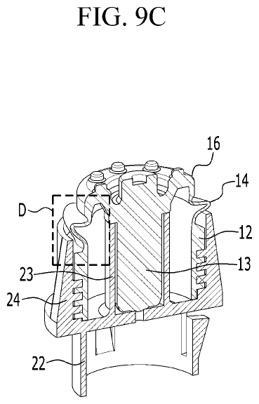

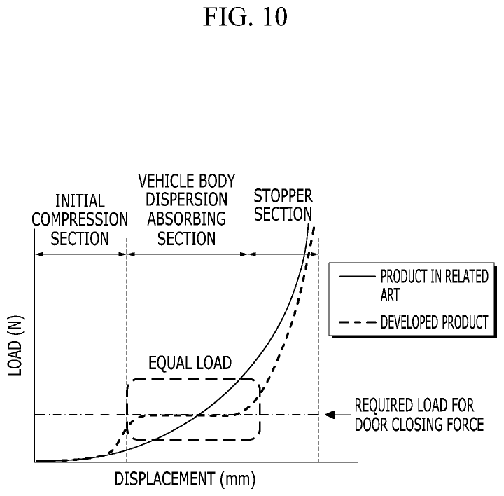

FIGS. 9A to 9C are views illustrating states in which a protrusion portion is deformed when an external compressive force is applied to the over-slam bumper device for a vehicle according to an embodiment of the present invention, and FIG. 10 is a view illustrating a change in load applied to the protrusion portion as the external compressive force is applied to the over-slam bumper device for a vehicle according to an embodiment of the present invention.

Referring to FIG. 9 (9A to 9C), rigidity of the bumper part 10 in an initial compression section may be set by setting in advance a thickness t of the outer wall of the bumper part 10 (FIG. 9A). When an external compressive force is applied through the contact portion 16, the deformable portion 14 of the bumper part 10 protrudes in a rounded shape toward an outer radius as illustrated in part ‘C’ (FIG. 9B). Further, when the external compressive force is maximally applied, the deformable portion 14 of the bumper part 10 maximally protrudes in a rounded shape toward the outer radius as illustrated in part ‘D’ (FIG. 9C). Meanwhile, an end u of the protruding portion 13 further provided in the bumper part 10 is inserted into the insertion portion 23 provided in the second bracket 24 and comes into contact with the bottom surface of the second bracket 24. In addition, a connection portion s between the contact portion 16 and the protruding portion 13 of the bumper part 10 comes into contact with part ‘B’, which is an end of the insertion portion 23. That is, when the external compressive force is maximally applied, the deformable portion 14 of the bumper part 10 is maximally compressed and deformed. In this case, the end u of the protruding portion 13 comes into contact with the bottom surface of the second bracket, and the connection portion s between the contact portion 16 and the protruding portion 13 comes into contact with the end of the insertion portion 23 of the second bracket.

Referring to FIG. 10, the load, which is transmitted to the bumper part 10 by the deformation of the deformable portion 14, is maintained almost constantly (vehicle body dispersion absorbing section) when in the initial compression section, the load transmitted to the bumper part 10 is exponentially increased, the tailgate 1 is closed, and the bumper part 10 comes into contact with the rear bumper 2 or the vehicle body. In addition, when the external compressive force is maximally applied after the bumper part 10 comes into contact with the rear bumper 2 or the vehicle body, the load transmitted to the bumper part 10 is exponentially increased again (stopper section).

In the over-slam bumper device in the related art, the load transmitted to the bumper part is exponentially increased equally in all sections. However, in the over-slam bumper device 100 according to embodiments of the present invention, almost the same load may be applied to the bumper part 10 in the vehicle body dispersion absorbing section. Therefore, the equal load is applied by the deformation of the bumper part 10 even though the amount of overlap is changed when the tailgate 1 is closed. Therefore, it is possible to mitigate the difficulty in closing the tailgate 1 due to vehicle body dispersion and assembly dispersion.

As described above, according to the over-slam bumper device for a vehicle according to an embodiment of the present invention, the equal load is applied by the deformation of the bumper part even though the amount of overlap is changed when the tailgate is closed, which makes it possible to absorb vehicle body dispersion and assembly dispersion.

In addition, according to the over-slam bumper device for a vehicle according to an embodiment of the present invention, the amount of adjustment of the stepped portion may be changed by rotating the bumper part relative to the bracket part.

In addition, according to the over-slam bumper device for a vehicle according to an embodiment of the present invention, the protrusion is disposed such that the relative position thereof is changed depending on the relative rotation between the bumper part and the bracket part. Therefore, it is possible to check, with the naked eye, the rotation position of the bumper part relative to the bracket part and to adjust the amount of overlap.

While the exemplary embodiments of the present invention have been described, the present invention is not limited to the embodiments. The present invention covers all modifications that can be easily made from the embodiments of the present invention by those skilled in the art and considered as being equivalent to the present invention.

What is claimed is:

1. An over slam bumper device for a vehicle, the over slam bumper device comprising:
a bracket part having one end protruding toward an inside of a tailgate of the vehicle and the other end protruding toward a rear bumper or a vehicle body of the vehicle and fixable to the tailgate; and
a bumper part inserted into the bracket part and protruding toward the rear bumper or the vehicle body,
wherein the bracket part has a hollow shape and comprises:
a first bracket protruding toward the inside of the tailgate, and
a second bracket protruding toward the outside of the tailgate and having an inner wall on which a screw thread is formed,
wherein the bumper part has a hollow shape and comprises:
a coupling portion inserted into the second bracket and having an outer wall on which a screw thread is formed,
a deformable portion integrally extending from the coupling portion toward the outside of the tailgate and configured to be compressed and deformed when an external force is applied, and
a contact portion integrally extending from the deformable portion toward the outside of the tailgate and configured to come into direct contact with the rear bumper or the vehicle body when the tailgate is closed, and
wherein the bumper part is inserted into the second bracket.

2. The over slam bumper device of claim 1, further comprising a sealing member interposed between the tailgate and the bracket part and configured to seal the bracket part and the tailgate.

3. The over slam bumper device of claim 1, wherein the bracket part further comprises an insertion portion in the second bracket, and wherein the insertion portion integrally extends from an inner surface of the second bracket.

4. The over slam bumper device of claim 1, wherein the bumper part further comprises a protruding portion integrally extending from the contact portion and inserted into the insertion portion.

5. The over slam bumper device of claim 1, wherein the screw thread formed on the outer wall of the coupling portion is screw-coupled to the screw thread formed on the inner wall of the second bracket such that the bumper part is fixed to the bracket part.

6. The over slam bumper device of claim 5, wherein the bumper part is moved relative to the bracket part by being rotated in a state in which the bumper part is screw-coupled to the bracket part.

7. The over slam bumper device of claim 6, wherein the deformable portion is deformed to protrude into a rounded shape toward an outer radius of the bumper part when an external compressive force is applied.

8. The over slam bumper device of claim 7, wherein a lower surface of the protruding portion is disposed in the insertion portion and comes into contact with an inner surface of the second bracket when the external compressive force is applied to the bumper part.

9. The over slam bumper device of claim 1, wherein the contact portion comprises a plurality of protrusions protruding in a direction perpendicular to a surface of the contact portion.

10. The over slam bumper device of claim 1,
wherein a first protrusion is formed on an outer wall of the deformable portion and protrudes outward in a direction perpendicular to the outer wall of the deformable portion,
wherein a second protrusion is formed on an outer wall of the second bracket and protrudes in a direction perpendicular to the outer wall of the second bracket, and
wherein the first protrusion and the second protrusion are disposed such that a relative position between the first protrusion and the second protrusion is changed depending on a relative rotation between the bumper part and the bracket part.
